(19) United States
(12) Patent Application Publication
(10) Pub. No.: US 2024/0310227 A1
(43) Pub. Date: Sep. 19, 2024

(54) FLUID COMPONENT, VEHICLE COMFORT SYSTEM, AND METHOD FOR OPERATING SUCH A SYSTEM

(71) Applicant: Faurecia Autositze GmbH, Hannover (DE)

(72) Inventors: Piotr CEGLAREK, Katowice (PL); Robert GRZESLO, Swidnica (PL); Tomasz STASINSKI, Dzierzoniow (PL); Jérémie THERRY, Wroclaw (PL); Stephane BUCHHEIT, Trie Chateau (FR)

(73) Assignee: Faurecia Autositze GmbH, Hannover (DE)

(21) Appl. No.: 18/444,643

(22) Filed: Feb. 17, 2024

(30) Foreign Application Priority Data
Mar. 13, 2023 (DE) 102023106135.6

(51) Int. Cl. G01L 9/00; B60N 2/90; F16K 7/17

(52) U.S. Cl. CPC G01L 9/0072; F16K 7/17; B60N 2/90

(57) ABSTRACT

A fluid component, a vehicle comfort system, and a method for operating the system in which the fluid component has the function of a pressure sensor and/or valve for a fluid-conducting system of a vehicle comfort system, and in which at least one actuator is accommodated, and preferably in a preferably fluid-tight or non-fluid-tight housing of the fluid component. Each actuator has at least two electrodes and at least one section arranged between them having an electroactive polymer (EAP), or a plurality of sections having an electroactive polymer (EAP) layered on top of one another.

### CROSS REFERENCE TO RELATED APPLICATIONS

This patent application claims the benefit of and priority on German Patent Application No. 10 2023 106 135.6 having a filing date of 13 Mar. 2023.

### BACKGROUND OF THE INVENTION

### Technical Field

The invention relates to a fluid component. Fluid components are components of a fluid-conducting system that come into contact with the fluid-preferably air-during operation of the fluid-conducting system. The present case primarily concerns fluid components that comprise the function of a pressure sensor and/or valve.

### Prior Art

Specifically, the invention relates to a vehicle comfort system in which such a fluid component is used. Vehicle comfort systems are primarily vehicle seat comfort systems with adjustment and/or massage functions. Fluid actuators such as fluid-fillable bladders are used for this purpose, with which parts of a vehicle seat can be adjusted, or, for example, massage functions can be realized.

For this purpose, in a fluid-conducting system, which is usually supplied with fluid by a pump or the like, various fluid components are used that can influence the flow path of the fluid or that are designed to measure characteristic properties such as pressures at various points in the system.

For pressure measurement, microelectronic mechanical systems (MEMS) are often used, in which pressure measurement takes place via the deformation of an elastic element caused by the fluid pressure. However, these systems are relatively expensive.

It is therefore the object of the present invention to provide a fluid component, a vehicle comfort system, and a method for operating such a system, in which the use of expensive MEMS can be dispensed with, and which can thus be designed to be lower in cost.

### BRIEF SUMMARY OF THE INVENTION

This object is achieved by a fluid component with the function of a pressure sensor and/or valve for a fluid-conducting system of a vehicle comfort system, in which at least one actuator is accommodated, and preferably in a-preferably fluid-tight or non-fluid-tight-housing of the fluid component, wherein each actuator has at least two electrodes and at least one section having an electroactive polymer (EAP) arranged between them, or a plurality of sections having an electroactive polymer (EAP), layered on top of one another; and a vehicle comfort system, and preferably a vehicle seat comfort system, having a fluid-conducting system and at least one fluid component—preferably arranged on a circuit board (9)—as taught herein.

This object also is achieved by a method for operating a vehicle comfort system as taught herein in which the actuator closes the inlet and by means of the evaluation device determines an associated pressure value from the voltage (V2) detected by the detection device, which pressure value is representative of the fluid pressure in the fluid line.

This object further is achieved by a method for operating a vehicle comfort system as taught herein in which the one actuator is deformed by applying a predetermined voltage (V4), and the inlet is thereby opened, so that a fluid flow takes place from the inlet through the fluid component with the functionality of a valve through the outlet into the fluid actuator, wherein the voltage (V6) between the electrodes of the further actuator is detected at the further actuator by means of the or a detection device, and an associated pressure value which is representative of the pressure within the fluid actuator is determined by means of the evaluation device.

Advantageous embodiments can be found in the dependent claims.

First of all, this object is achieved according to the invention by a fluid component which is equipped with the function of a pressure sensor and/or valve and which is designed for a fluid-conducting system of a vehicle comfort system. In the fluid component according to the invention, at least one actuator is accommodated, and preferably in a—preferably fluid-tight or non-fluid-tight—housing of the fluid component. In the following, fluid means any medium capable of flowing; preferably, air is used in the present invention. In this case, the fluid-conducting system would be a pneumatic system. If the housing of the fluid component, if present, is sealed in a fluid-tight manner, meaning that a chamber surrounding the at least one actuator is fluid-tight, this fluid component can be used to measure an absolute pressure within the fluid-conducting system. Conversely, if said chamber surrounding the at least one actuator is not sealed in a fluid-tight manner, e.g., by allowing fluid to be released to the outside environment through a corresponding outlet, e.g., an opening in a printed circuit board on which the fluid component is arranged, then the fluid component can be used as a relative sensor—for example, to measure ambient pressure outside a fluid-conducting system.

According to the invention, each actuator has at least two electrodes and at least one section having an electroactive polymer (EAP) arranged between them, or a plurality of sections having an electroactive polymer layered on top of one another.

The electroactive polymer mentioned has the property that, on the one hand, a deformation—possibly elastic—of the polymer causes the voltage and/or capacitance between the electrodes to change, because the polymer influences the electric field between the two electrodes. On the other hand, the electroactive polymer has the property that it is, conversely, deformed-possibly elastically-when an electrical voltage is applied across the electrodes. On the one hand, this actuator can thereby be used to determine a force exerted on it by measuring the electrical voltage between the electrodes, and from this to draw conclusions about the mechanical pressure; on the other, this actuator can be used as an active component to control fluid-related processes—for example, to open and close valves.

This can be done in a very elegant way and is much cheaper and more universally applicable than the MEMS described above.

The invention also relates to a vehicle comfort system, and preferably a vehicle seat comfort system, which has a fluid-conducting system and at least one fluid component-preferably arranged on a circuit board—as described above.

Preferably, the fluid-conducting system comprises a fluid pump that feeds a fluid line with fluid. This fluid is preferably air. The fluid line, which can be designed for example as a common rail, is connected fluidically to one or to a plurality of fluid actuator(s), and preferably one or a plurality of fluid-fillable bladder(s), via one or a corresponding plurality of supply line(s). Individual components of the fluid-conducting system, such as valves, electronics, sensors, e.g., pressure sensors, can here advantageously be arranged on a circuit board. This enables a particularly compact and integrative design of the device as a whole.

An advantageous embodiment of the vehicle comfort system according to the invention provides that the at least one fluid component comprise the function of a pressure sensor. The fluid component here has an inlet via which it is connected to the fluid line or/and to a supply line. This connection is preferably designed such that the at least one actuator is deformed under fluid pressure. For example, the fluid in the fluid line can press against the actuator via the inlet. In the case described, the vehicle comfort system has a detection device that detects the voltage and/or capacitance between the electrodes of the actuator. This voltage-meaning an electrical voltage—or the capacitance changes as a result of the deformation of the electroactive polymer, because a change in the electrical field between the two electrodes takes place. This change is representative of a change in the pressure, which is measured via the pressure sensor designed in this way. The vehicle comfort system according to the invention therefore preferably further comprises an evaluation device which determines an associated pressure value from the electrical voltage and/or capacitance between the two electrodes detected by the detection device. In this way, the pressure can be measured via a voltage measurement or capacitance measurement. If the inlet has a connection to the fluid line, the pressure in the fluid line can be measured in this way, for example. Of course, other lines of the fluid-conducting system can also be measured with a corresponding pressure sensor.

As described above, the present invention not only allows a voltage change or capacitance change due to a pressure change to be determined, but, also, an induced voltage change in the electrical voltage applied to the electrodes of an actuator then causes a mechanical deformation of the electroactive polymer of the actuator. However, the change in shape can then be used to exert a targeted movement of the actuator; for example, a stroke movement thus brought about can be used to open or close flow paths.

According to an advantageous embodiment of the present invention, it is therefore provided that, in at least one supply line, the at least one or a further fluid component comprise the function of a valve for opening and closing a flow path through the supply line. Here, the vehicle comfort system has a voltage supply which can apply a predetermined or predeterminable electrical voltage between the electrodes of the actuator. The actuator is arranged in such a way here that, below a threshold voltage or in the absence of a voltage between the electrodes, the fluid component with the function of a valve closes a passage. Closing means that an existing flow of fluid is interrupted by the valve. It can be provided here that the fluid component comprising the function of a valve comprise an inlet connected to the supply line and at least one outlet connected directly or indirectly to a fluid actuator via a supply line. The actuator is preferably used to open and close the inlet.

When an actuator is spoken of above or in the following, this refers to actuators or components that are different from the fluid actuator, which can be designed as a fluid-fillable bladder. The fluid actuator thus does not fall under the designation, actuator. An actuator, in the sense of this invention, is the combination of electrodes described above and in the following, and at least one section of electroactive polymer arranged between them.

In fluidic systems, such as pneumatic systems, there are solutions in which fluid-fillable bladders are filled by means of such valves and emptied by means of other valves. However, it is also possible to design a single valve—or, better, a single fluid component—in such a way that both flow directions, filling and emptying, are possible. It is preferably provided in such a case that the fluid component comprising the function of a valve further have a vent outlet. Such a vent outlet is often designed merely as an opening in the housing of a valve, which is then opened by suitable measures to empty the fluid actuator or a bladder when the flow path to the supply line is closed, or is closed to fill the fluid actuator when the flow path to the supply line is open. An embodiment in which the vehicle comfort system according to the invention comprises a further actuator is particularly advantageous. This further actuator, and actually any actuator that is present, can then be used for example to measure pressures and/or for opening or closing.

According to a particularly advantageous embodiment, the or a further power supply can apply a predetermined or predeterminable electrical voltage between the electrodes of the further actuator. The additional actuator is arranged in such a way that the vent outlet is closed below a threshold voltage or when there is no voltage between its electrodes.

In general, it is the case that the actuators can themselves have elastic properties; depending upon the application, such elastic properties can also originate entirely or additionally from additional components. Such additional components can be elastic elements such as springs. These elastic elements can pre-stress the electroactive polymer sections of the actuators, for example, into a preferred position—for example, a neutral position or closed position or open position. Such an elastic element can also be used to inhibit its deformation, e.g., in the realization as a pressure sensor, by arranging it as a compression spring element on the side, facing away from the inlet, of the actuator. Accordingly, such an elastic element can already be pre-stressed or not pre-stressed in its initial state. All of these measures ultimately support the compression level and, for example, have an influence on the response behavior of a fluid component equipped with the actuator. If the actuators themselves have elastic properties, the actuators, or the section of electroactive polymer, can be compressed or stretched in an initial state instead of or in addition to a separate elastic element such as a spring. This also provides a pre-stressing. The deformation of the section of electroactive polymer can be effected in various ways—for example, by exerting pressure forces, tensile forces, or compression forces and the like.

It is therefore preferably provided that at least one actuator, and preferably a plurality or each of the actuators, be supported by an additional elastic element, and preferably a tension spring element or compression spring element. If the fluid component comprises the function of a valve, then, for example, the elastic element is arranged and designed in such a way that it presses the actuator in the direction of a corresponding valve seat. This is an example of a pre-stressing into a closed position.

Within the method disclosed herein according to the invention, the vehicle comfort system according to the invention can be operated in different ways:

Insofar as additional features as taught herein are preferably present, it can be provided that, in such a method, the actuator close the inlet and, by means of the evaluation device, determine from the voltage detected by the detection device an associated pressure value which is representative of the fluid pressure in the fluid line. In such a case, the compression of the actuator therefore measures the static pressure of the fluid line—for example, the pressure in a common rail.

Insofar as additional features as taught herein are preferably present, the method according to the invention can comprise that the one actuator be deformed by the application of a predetermined voltage, and the inlet thereby be opened, so that a fluid flow take place from the inlet through the fluid component with the functionality of a valve through the outlet into the fluid actuator. Here, at the additional actuator, the electrical voltage between the electrodes of the additional actuator is detected by means of the or a detection device, and an associated pressure value is determined by means of the evaluation device, which value is representative of the pressure within the fluid actuator. This additional actuator is preferably simultaneously used to empty the fluid actuator by the application of an electrical voltage. In the present case, the two actuators can thus, on the one hand, be used to open or close a valve and, on the other, when they are, for example, in the closed position, to exert the function of a pressure sensor.

### BRIEF DESCRIPTION OF THE DRAWINGS

The invention is explained in more detail below with reference to FIGS. 1-10.

FIG. 1 shows a fluid component according to the invention in the function as a pressure sensor in sectional view in an initial state according to a first embodiment according to the invention.

FIG. 2 shows the fluid component from FIG. 1 with a deformed actuator in a deformed state.

FIG. 3 shows a fluid component according to the invention in the function as a pressure sensor in a sectional view in an initial state according to a second embodiment according to the invention.

FIG. 4 shows the fluid component from FIG. 3 with a deformed actuator in a loaded state.

FIG. 5 shows an example of a fluid-conducting system used, in the context of the invention, as a fluid circuit diagram.

FIG. 6 shows a fluid component according to the invention in the function as a valve and/or pressure sensor in a sectional view in an initial state according to a third embodiment according to the invention.

FIG. 7 shows the fluid component from FIG. 6 with a deformed actuator in a loaded state.

FIG. 8 shows a fluid component according to the invention in the function as a valve and/or pressure sensor in a sectional view in an initial state according to a fourth embodiment according to the invention.

FIG. 9 shows the fluid component from FIG. 8 with deformed actuator in a loaded state.

FIG. 10 shows a fluid component according to the invention in the function as a valve and/or pressure sensor with a plurality of actuators in a sectional view according to a fifth embodiment according to the invention.

### DETAILED DESCRIPTION OF PREFERRED EMBODIMENTS

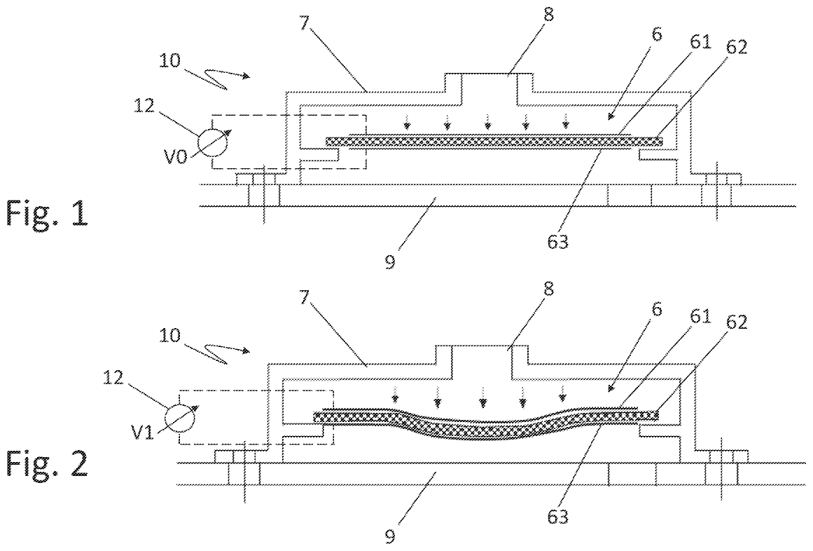

FIGS. 1 and 2 show a first embodiment of the fluid component 5, 10 as a pressure sensor 10 in cross-section. A housing 7 is arranged on a circuit board 9. The space enclosed by the circuit board 9 and housing 10 is divided by an actuator 6 into two sub-chambers which are thereby hermetically separated from one another. The upper sub-chamber is provided with an inlet 8, with which this sub-chamber can be connected to a system of lines, for example. The lower sub-chamber can be hermetically sealed or can be connected to the atmosphere by means of a passage through the circuit board 9. The actuator 6 contains an electroactive polymer (EAP) 62, which seals the two sub-chambers relative to each other. The EAP 62 is arranged between two electrodes 61, 63. A detection device 12—here, a voltmeter—measures the voltage V0, V1 and/or the capacitance between the electrodes 61, 63. FIG. 1 shows the idle position of the actuator 6, in which the detection device indicates an idle voltage V0. In FIG. 2, the pressure in the upper sub-chamber has been increased, which causes the EAP 62 and the electrodes 61, 63 arranged on it to deform downwards. The deformation changes the dielectric size of the EAP 62, which leads to a change in the voltage and/or capacitance between the electrodes 61, 63, which is measured as V1 at the detection device 12. With a calibrated pressure sensor 10, the pressure, or the pressure difference, between the two sub-chambers can be determined in this way. If the lower sub-chamber is closed, the absolute pressure in the upper sub-chamber can be determined; if the lower sub-chamber is connected to the atmosphere, the relative air pressure of the upper sub-chamber can be determined.

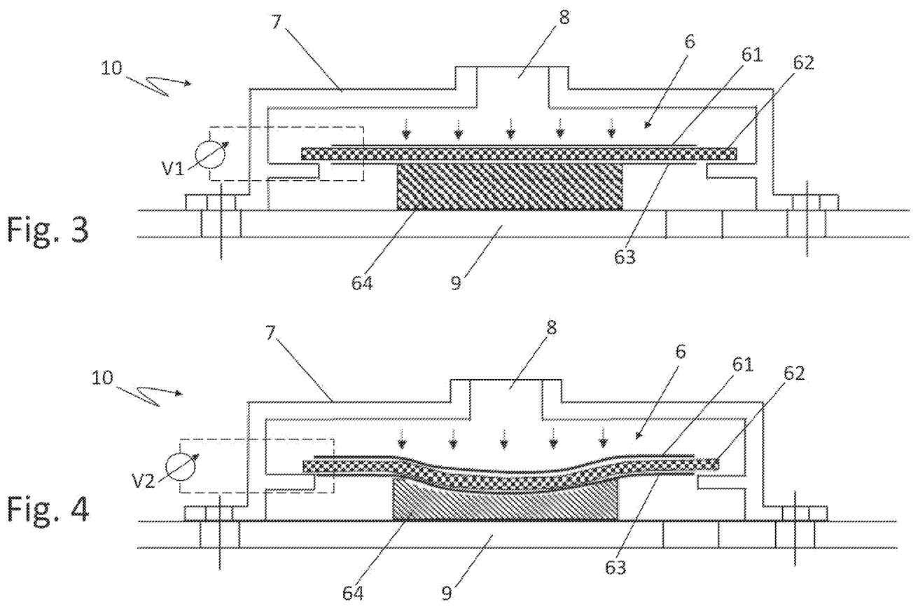

The embodiment of a fluid component 5, 10 according to the invention shown in FIGS. 3 and 4 differs from the first embodiment according to FIGS. 1 and 2 in that the actuator 6 is not supported solely on the edge on the housing 7, but rests-preferably centrally-on an elastic element 64. This allows larger pressure fluctuations in a line system connected to the inlet (not shown here) to be measured, because the pressure in the upper sub-chamber has to bend not only the actuator 6, but also the elastic element 64. Without limitation of generality, the elastic material can be an elastic solid material, a foam, a pressurized gas bladder, or a compression spring.

Compared to the first embodiment shown in FIGS. 1 and 2, the embodiment shown here has a larger measurement range.

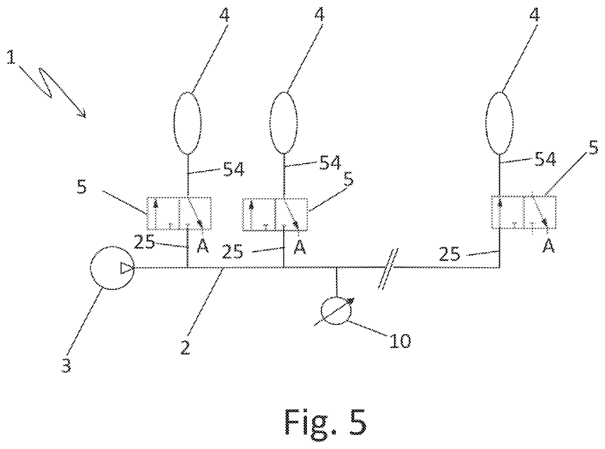

FIG. 5 shows an example of a fluid-conducting system 1 used, in the context of the invention, as a fluid circuit diagram. The fluid line 2, which is preferably designed here as a common rail, is filled by a fluid pump 3, wherein the fill-level is measured by means of a fluid component 10 designed as a pressure sensor 10. From the fluid line 2, supply lines 25 branch off to further fluid components 5 designed as valves 5, the exact function of which is explained in more detail in the following figures. The valves 5 shown here are designed as two-way valves. Each valve 5 has an outlet which is connected with the supply line 54 to a fluid actuator 4, and an outlet A through which the fluid can be discharged from the fluid-conducting system 1. The two left valves 5 are set to discharge the fluid from the fluid actuator 4; the fluid actuator 4 will be emptied. The right valve 5, on the other hand, is set to filling, i.e., the fluid actuator 4 will be filled from the fluid line 2.

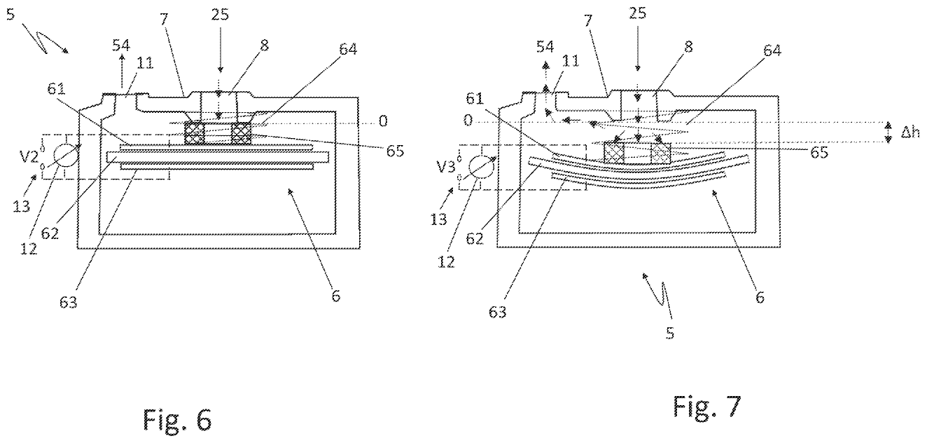

FIGS. 6 and 7 show a further exemplary embodiment of a fluid component according to the invention as valve 5. An inlet 8, which is connected to the supply line 25 from the fluid line 2, is arranged approximately centrally at the top in the housing 7; an outlet, to which the supply line 54 to the fluid actuator 4 is connected, is arranged at the edge of the upper housing 7, shown here on the left-hand side. The actuator 6, which has an EAP 62 that is arranged between two electrodes 61, 63, does not rest solely with its edge on a housing part 7 (not shown here), but, rather, is additionally provided at the top with a sealing element 65, designed for example as a sealing ring, and is pulled upwards by means of a tension spring 64, so that the sealing element 65 is pressed/drawn against a valve seat of the inlet 8 and seals it.

If this state shown in FIG. 6 is regarded as the idle state, then it is advantageous if the voltage supply 13 does not have to generate a voltage in order to stabilize the state. On the one hand, in the event of a power failure, a valve position is defined, and on the other, the possibility results of measuring the voltage V2 and/or capacitance between the electrodes 61 and 63 at the detection device and thus of measuring the pressure difference between the supply line 25 and the fluid actuator 4; the fluid from the supply line 25 presses centrally from above, and the fluid from the fluid actuator 4 presses on the rest of the actuator 6.

In this idle state, the lower edge of the valve seat around the inlet 8 lies against the upper edge of the sealing element 65, and its position is defined as the height “0” of the idle position. If the valve 5 is to be opened, then, as shown in FIG. 7, a voltage V3 is applied to the electrodes from the power supply 13, which causes the EAP 62 to bend, i.e., to bulge downwards in the middle. As a result, the actuator 6 pulls the sealing element 65 downwards by the distance Δh against the tensile force of the tension spring 64, and thus clears the path of the fluid from the supply line 25 to the outlet 11 to the fluid actuator 4 (arrows). If the power supply 13 is switched off again, the curvature of the EAP 62 is canceled, and the valve 5 returns to the state shown in FIG. 6; the valve 5 closes.

Alternatively, it is also possible for the actuator 6 to be suspended from the tension spring 64 alone. Then, however, at least the housing 7 immediately above the EAP 62 would have to have a valve seat or an edge so that the EAP 62 could be supported on it, in order to, with the bending, be supported on it, in the event that voltage V3 is applied, thus being able to pull on the tension spring 64 in the middle and to pull the sealing element off the valve seat around the inlet 8.

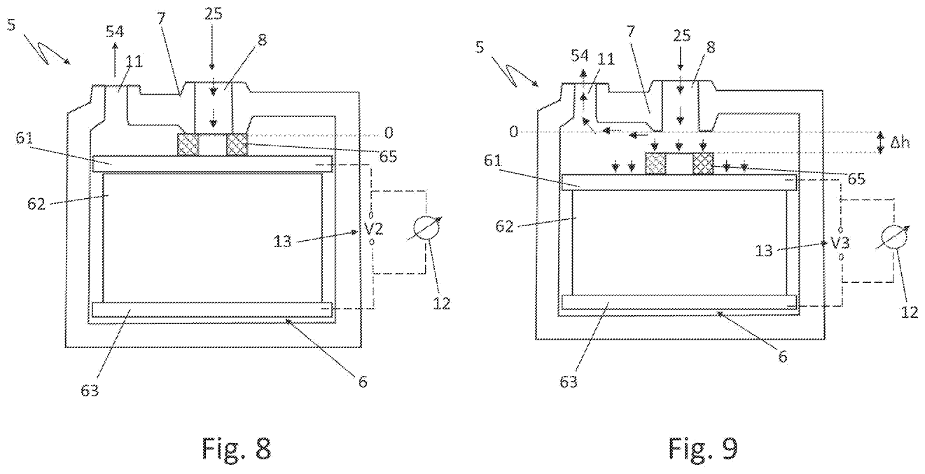

In the embodiment of a fluid component 5, 10 designed as a valve 5, shown in FIGS. 8 and 9, the actuator 6 is not attached to the housing 7 at its edge. The electroactive polymer 62 is arranged as a thick material-preferably applied in several layers-between the electrodes 61, 63 in such a way that it shrinks in height when voltage is applied to the electrodes. Thus, the lower electrode 63 can either stand on the floor of the housing 7 or (nonetheless) be attached to the side walls. A sealing element 65 is again arranged on the upper electrode 61, which, in the idle state shown in FIG. 8, presses against the valve seat of the inlet 8 and seals the inlet. If, as shown in FIG. 9, a voltage V3 is now applied to the electrodes 61, 63 from the power supply 13, the thickness of the EAP 62 shrinks by the height Δh, and the sealing element 65 is lowered accordingly by the amount Δh and releases the passage from the supply line 25 at the inlet 8 to the supply line 54 to the fluid actuator 4.

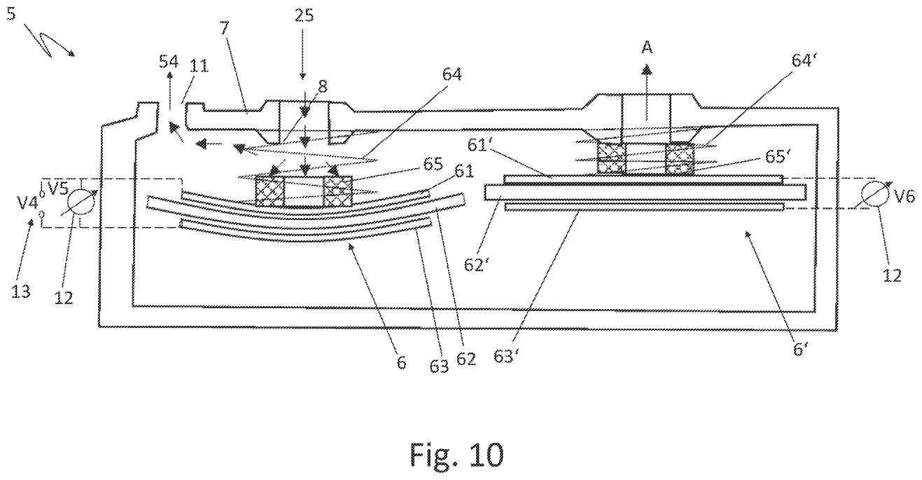

FIG. 10 shows an exemplary embodiment of a two-way system of a fluid component 5, 10 designed as a valve 5. Referring to the exemplary embodiment in FIGS. 6 and 7, the left part of the housing 7 shows the open valve 5 as shown in FIG. 7. At the actuator 6, a voltage V4 is applied to the electrodes 61, 63 by the power supply 13, so that the inlet 8 of the valve 5 opens; the fluid actuator 4 is filled. The illustration in FIG. 7 is supplemented by a further actuator 6′, which is not arranged at an inlet 8, but at a vent outlet A. This outlet A of valve 5 is closed. Since no voltage is applied to the electrodes 61′, 63′, the detection device 12 can measure the voltage V6 and/or a capacitance, and can thus determine the pressure difference between the outlet A and the fluid actuator 4.

If the power supply 13 is switched off, the inlet 8 closes, and the left detection device 12 can measure the voltage V5 and/or the capacitance between the electrodes 61, 63, and in this way the pressure difference between the supply line 25 and the fluid actuator 4 can be determined.

If the outlet is opened by applying a voltage V6 between the electrodes 61′, 63′, the fluid actuator 4 is emptied. The detection device 12 at the inlet 8 can also measure the pressure difference between the supply line 25 and the fluid actuator 4. With the use of a fluid component 5 according to the invention as a two-way valve, a pressure difference can be measured without additional components, the difference from the external pressure is determined at the fluid inlet, and the difference from the line system 2 is measured at the fluid outlet.

In the examples described, a gaseous material was more or less implied as the fluid. Preferably, the fluid components 5, 10 according to the invention are also used with gaseous fluids, because the significantly greater compressibility of gases allows a greater bending effect to be achieved in the EAP's and thus in the actuators 6, 6′. The fluid components 5, 10, however, also function with liquids, wherein the bending or deformation effect is lower due to the greater resistance of the fluids, and thus an exact conversion becomes more difficult.

In the description of the exemplary embodiments as valve 5, the basic state was always spoken of when the valve 5 was closed. Of course, it is also possible for the basic state to be the open valve 5 and for this to be actively closed. Accordingly, the elastic element 64 would have to be a compression spring (FIGS. 6, 7, 10), and the EAP would have to expand under tension (FIGS. 8, 9), i.e., become higher.

### LIST OF REFERENCE SIGNS

1 fluid-conducting system
2 fluid line
3 fluid pump
4 fluid actuator
5 valve, fluid component
6,6′ actuator
7 housing
8 inlet
9 circuit board
10 pressure sensor, fluid component
11 outlet or inlet (to or from the fluid actuator)
12 detection device
13 voltage supply
25 supply line (to the fluid component)
54 supply line (to the fluid actuator)
61, 61′ electrode
62, 62º electroactive polymer(s) (EAP)
63, 63′ electrode
64, 64′ elastic element
65, 65′ sealing element
0 height in the idle position
Δh deflection from the idle position
A vent outlet
V0-V6 voltages

What is claimed is:

1. A fluid component (5, 10) with the function of a pressure sensor (10) and/or valve (5) for a fluid-conducting system (1) of a vehicle comfort system, in which at least one actuator (6, 6′) is accommodated, and preferably in a preferably fluid-tight or non-fluid-tight housing (7) of the fluid component, wherein each actuator (6, 6′) has at least two electrodes (61, 63; 61′, 63′) and at least one section (62; 62′) having an electroactive polymer (EAP) arranged between them, or a plurality of sections (62; 62′) having an electroactive polymer (EAP), layered on top of one another.

2. A vehicle comfort system, preferably a vehicle seat comfort system, having a fluid-conducting system (1) and at least one fluid component (5, 10), preferably arranged on a circuit board (9), the fluid component (5, 10) with the function of a pressure sensor (10) and/or valve (5) for a fluid-conducting system (1) of the vehicle comfort system, in which at least one actuator (6, 6′) is accommodated, and preferably in a preferably fluid-tight or non-fluid-tight housing (7) of the fluid component, wherein each actuator (6, 6′) has at least two electrodes (61, 63; 61′, 63′) and at least one section (62; 62′) having an electroactive polymer (EAP) arranged between them, or a plurality of sections (62; 62′) having an electroactive polymer (EAP), layered on top of one another.

3. The vehicle comfort system according to claim 2, wherein the fluid-conducting system (1) comprises a fluid pump (3) which feeds a fluid line (2) with fluid, wherein the fluid line (2) is fluidically connected to one or a plurality of fluid actuator(s) (4), and preferably one or a plurality of fluid-fillable bladder(s), via one or a corresponding plurality of supply line(s) (25, 54).

4. The vehicle comfort system according to claim 3, wherein the at least one fluid component (5, 10) comprises the function of a pressure sensor and has an inlet (8) via which it is connected to the fluid line (2) and/or a supply line (25, 54) in such a way that the at least one actuator (6, 6′) is deformed under fluid pressure, wherein the vehicle comfort system has a detection device (12) which detects the voltage (V0, V1) and/or capacitance between the electrodes (61, 63; 61′, 63′) of the actuator (6, 6′).

5. The vehicle comfort system according to claim 4, further comprising an evaluation device which determines an associated pressure value from the voltage (V0, V1) and/or capacitance detected by the detection device (12).

6. The vehicle comfort system according to claim 3, wherein, in at least one supply line (25, 54), the at least one or a further fluid component (5, 10) comprises the function of a valve (5) for opening and closing a flow path through the supply line (25, 54), wherein the vehicle comfort system has a voltage supply (13) which can apply a predetermined or predeterminable voltage (V2, V3) between the electrodes (61, 63; 61′, 63′) of the actuator (6, 6′), wherein the actuator (6, 6′) is arranged such that the valve (5) closes below a threshold voltage (V2) or when there is no voltage between the electrodes (61, 63; 61′, 63′).

7. The vehicle comfort system according to claim 6, wherein the fluid component (5, 10) comprising the function of a valve (5) comprises an inlet (8) connected to the supply line (25) and at least one outlet (11) connected directly or indirectly to a fluid actuator (4) via a supply line (54).

8. The vehicle comfort system according to claim 6, wherein the fluid component (5, 10) comprising the function of a valve (5) further has a vent outlet (A).

9. The vehicle comfort system according to claim 8, further comprising a further actuator (6′).

10. The vehicle comfort system according to claim 9, wherein the or a further power supply (13) can apply a predetermined or predeterminable voltage (V2, V3) between the electrodes (61′, 63′) of the further actuator (6′), and this further actuator (6′) is arranged such that the vent outlet (A) is closed below a threshold voltage (V2) or when there is no voltage between its electrodes (61′, 63′).

11. The vehicle comfort system according to claim 2, wherein at least one actuator (6; 6′), and preferably a plurality or each of the actuators (6; 6′), is supported by an additional elastic element (64; 64′), and preferably a tension spring or compression spring element.

12. The vehicle comfort system according to claim 10, wherein, if the fluid component (5, 10) comprises the function of a valve (5), the elastic element (64; 64′) is arranged and designed in such a way that it presses the actuator (6, 6′) in the direction of a corresponding valve seat.

13. A method for operating a vehicle comfort system in which the actuator (6) closes the inlet (8) and by means of the evaluation device determines an associated pressure value from the voltage (V2) detected by the detection device (12), which pressure value is representative of the fluid pressure in the fluid line (2), wherein the vehicle comfort system is preferably a vehicle seat comfort system having a fluid-conducting system (1) and at least one fluid component (5, 10), preferably arranged on a circuit board (9), the fluid component (5, 10) with the function of a pressure sensor (10) and/or valve (5) for a fluid-conducting system (1) of the vehicle comfort system, in which at least one actuator (6, 6′) is accommodated, and preferably in a preferably fluid-tight or non-fluid-tight housing (7) of the fluid component, wherein each actuator (6, 6′) has at least two electrodes (61, 63; 61′, 63′) and at least one section (62; 62′) having an electroactive polymer (EAP) arranged between them, or a plurality of sections (62; 62′) having an electroactive polymer (EAP), layered on top of one another, wherein the fluid-conducting system (1) comprises a fluid pump (3) which feeds a fluid line (2) with fluid, wherein the fluid line (2) is fluidically connected to one or a plurality of fluid actuator(s) (4), and preferably one or a plurality of fluid-fillable bladder(s), via one or a corresponding plurality of supply line(s) (25, 54), and wherein the at least one fluid component (5, 10) comprises the function of a pressure sensor and has an inlet (8) via which it is connected to the fluid line (2) and/or a supply line (25, 54) in such a way that the at least one actuator (6, 6′) is deformed under fluid pressure, wherein the vehicle comfort system has a detection device (12) which detects the voltage (V0, V1) and/or capacitance between the electrodes (61, 63; 61′, 63′) of the actuator (6, 6′).

14. A method for operating a vehicle comfort system in which the one actuator (6) is deformed by applying a predetermined voltage (V4), and the inlet (8) is thereby opened, so that a fluid flow takes place from the inlet (8) through the fluid component with the functionality of a valve (5) through the outlet (11) into the fluid actuator, wherein the voltage (V6) between the electrodes (61′, 63′) of the further actuator (6′) is detected at the further actuator (6′) by means of the or a detection device, and an associated pressure value which is representative of the pressure within the fluid actuator (4) is determined by means of the evaluation device, wherein the vehicle comfort system is preferably a vehicle seat comfort system having a fluid-conducting system (1) and at least one fluid component (5, 10), preferably arranged on a circuit board (9), the fluid component (5, 10) with the function of a pressure sensor (10) and/or valve (5) for a fluid-conducting system (1) of the vehicle comfort system, in which at least one actuator (6, 6′) is accommodated, and preferably in a preferably fluid-tight or non-fluid-tight housing (7) of the fluid component, wherein each actuator (6, 6′) has at least two electrodes (61, 63; 61′, 63′) and at least one section (62; 62′) having an electroactive polymer (EAP) arranged between them, or a plurality of sections (62; 62′) having an electroactive polymer (EAP), layered on top of one another, wherein the fluid-conducting system (1) comprises a fluid pump (3) which feeds a fluid line (2) with fluid, wherein the fluid line (2) is fluidically connected to one or a plurality of fluid actuator(s) (4), and preferably one or a plurality of fluid-fillable bladder(s), via one or a corresponding plurality of supply line(s) (25, 54), and wherein the at least one fluid component (5, 10) comprises the function of a pressure sensor and has an inlet (8) via which it is connected to the fluid line (2) and/or a supply line (25, 54) in such a way that the at least one actuator (6, 6′) is deformed under fluid pressure, wherein the vehicle comfort system has a detection device (12) which detects the voltage (V0, V1) and/or capacitance between the electrodes (61, 63; 61′, 63′) of the actuator (6, 6′).
